(19) United States
(12) Patent Application Publication
(10) Pub. No.: US 2006/0035195 A1
(43) Pub. Date: Feb. 16, 2006

(54) Method of transillumination of teeth

(75) Inventor: Adam Jacobs, Woodcliff Lake, NJ (US)

Correspondence Address: Rodney T. Hodgson, Ph.D., 822 Pines Bridge Rd., Ossining, NY, 10562, US

(73) Assignee: Electro Optical Sciences, Inc., Irvington-on-Hudson, NY (US)

(21) Appl. No.: 11/199,568

(22) Filed: Aug. 8, 2005

Related U.S. Application Data
(60) Provisional application No. 60/601,035, filed on Aug. 12, 2004.

(51) Int. Cl. A61C 1/00; A61C 5/00

(52) U.S. Cl. 433/29; 433/215

(57) ABSTRACT

A face of a tooth is illuminated with light obtained from an injection laser with a defined coherence, wherein the illuminating light impinging on the face of the tooth has less than the defined coherence. Light propagating from the illuminated face and scattered until it exits from another face of the tooth is captured to form an image of the other face of the tooth.

### CROSS REFERENCE TO RELATED APPLICATIONS

This application claims priority pursuant to 35 U.S.C. 119(e) to U.S. Provisional Application No. 60/601035 filed Aug. 12, 2004.

### FIELD OF THE INVENTION

The field of the invention is the field of transillumination of teeth

### BACKGROUND OF THE INVENTION

The background of the invention is well described in patents assigned to the assignee of the invention noted below.

### RELATED PATENTS AND APPLICATIONS

U.S. Pat. Nos. 6,714,657, 6,672,868, 6,341,957, 6,282,359, and 6,201,880, and U.S. Provisional Application No. 60/601035 filed Aug. 12, 2004, assigned to the assignee of the present invention, and all the references contained therein, are hereby included by reference in their entirety.

### OBJECTS OF THE INVENTION

It is an object of the invention to produce a light source for the transillumination imaging of teeth.

It is an object of the invention to produce a light source for the transillumination imaging of teeth having less power dissipation.

It is an object of the invention to produce a laser light source for the transillumination imaging of teeth having less speckle.

### SUMMARY OF THE INVENTION

An injection semiconductor laser designed for high power continuous duty is used as the light source for transillumination imaging of teeth. The laser is pulsed with a duty cycle between 5 and 30 percent. The speckle introduced in the transilluminated tooth image by the laser is reduced.

### DETAILED DESCRIPTION OF THE INVENTION

Prior art illumination systems for the transillumination of teeth have disclosed continuously operating incandescent light and light emitting diode (LED) light sources. The inventors have found an unanticipated problem in the transillumination imaging of teeth using low power (50 mw) injection laser sources. In transillumination imaging of teeth, the light is projected on to one face (or possibly two faces) of a tooth, and an unilluminated face of the tooth is imaged by the light escaping from the unilluminated face. The light rays inside the tooth are scattered multiple times, and the exit intensity of light produced by an injection laser or LED illumination source is remarkably uniform over the face of the tooth because of these multiple scatterings. When the light source was changed for a laser diode light source, however, a speckle pattern unexpectedly appeared. One of skill in the art would not expect such a pattern given the many light scattering events for each ray exiting from the tooth.

The problem of laser speckle introduced when a laser is used as an illumination source for lithography and microscopy on a rough surface has been treated many times, for example by U.S. Pat. No. 6,672,739 issued Jan. 6, 2004 (incorporated herein by reference in its entirety, including included references). In essence, a speckle pattern in ordinary imaging is “smoothed” by moving the image of an output optical fiber carrying the light over the time needed to form the image, or by means for reducing the coherence of the light giving rise to the speckle.

In the most preferred embodiment of the invention, an injection laser rated for much higher power than would be required for imaging is used, and that laser is pulsed at high power with a duty cycle set to give the average power required for the imaging. In one example, a 500 mW rated laser, was used in place of a 50 mW laser which gave an adequately exposed but speckled image. The laser, which had a spectral bandwidth of several nanometers, was run at a frequency of several kilohertz, and operated at a duty cycle of between 5% and 30%. Operating the laser in a pulsed mode reduces the speckle amplitude to a level that is adequate for tooth imaging and analysis.

An optical fiber is preferably used to carry the light from the laser diode to the tooth. The optical fiber has a large numerical aperture (N.A.) and a large core diameter. In a preferred embodiment, light from the laser is coupled into a second optical fiber which has a smaller core diameter and/or a smaller numerical aperture and light from that fiber is coupled into the larger core, larger N.A. fiber. The fibers are moved relative to one another, so that the light entering the larger core, larger N.A. fiber moves over the input face of the fiber and the light is smoothed at the exit face of the larger core, larger N.A. fiber. The relative motion of the light beam may be obtained by other means as known by one of skill in the art of moving light beams from lasers and from optical fibers.

Obviously, many modifications and variations of the present invention are possible in light of the above teachings. It is therefore to be understood that, within the scope of the appended claims, the invention may be practiced otherwise than as specifically described.

I claim:

1. A method of transillumination of teeth, comprising:
a) illuminating a first face of a tooth with light, the tooth illuminated with light provided by an injection laser, wherein the light from the injection laser has a defined coherence; then
b) imaging a second face of the tooth, the second face different than the first face, wherein a portion of the light illuminating the first face of the tooth enters the tooth, is multiply scattered, and exits the second face of the tooth to provide the image of the tooth;
wherein the average coherence of the light illuminating the first face of the tooth is less than the defined coherence of the injection laser over the time taken for the imaging of the second face of the tooth.

2. The method of claim 1, wherein the injection laser is operated in a pulsed mode with a duty cycle from 1% to 50%.

3. The method of claim 2, wherein the injection laser is operated in a pulsed mode with a duty cycle from 5% to 30%.

4. The method of claim 1, wherein light from the injection laser is injected into an entrance face of a first optical fiber, and wherein light exiting the exit face of the first optical fiber enters the entrance face of a second optical fiber, and wherein light exiting the exit face of the second optical fiber illuminates the first face of the tooth, and wherein the numerical aperture and core diameter of the first optical fiber are smaller than the numerical aperture and core diameter of the second optical fiber, and wherein the light entering the entrance face of the second optical fiber moves over the entrance face of the second optical fiber to change the mode structure exiting the second optical fiber during the time the second face of the tooth is imaged.
